(19) United States
(12) Patent Application Publication
(10) Pub. No.: US 2019/0346096 A1
(43) Pub. Date: Nov. 14, 2019

(54) CORE TROFFER LENS-RETAINER WITH BUILT IN AIR FUNCTIONALITY

(71) Applicant: SIGNIFY HOLDING B.V., EINDHOVEN (NL)

(72) Inventors: CHRISTOPHER PATRICK WARNER, HAMILTON, AL (US); CARLTON BRUCE PLUNK, SALTILLO, MS (US)

(21) Appl. No.: 16/337,451

(22) PCT Filed: Sep. 22, 2017
(86) PCT No.: PCT/EP2017/074070

§ 371 Date: Mar. 28, 2019

Related U.S. Application Data
(60) Provisional application No. 62/401,196, filed on Sep. 29, 2016.

(30) Foreign Application Priority Data
Oct. 25, 2016 (EP) 16195521.6

(51) Int. Cl. F21S 8/02; F21V 33/00

(52) U.S. Cl. CPC F21S 8/026; F24F 13/078; F21V 33/0088

(57) ABSTRACT

The invention provides a troffer-based lighting arrangement (100) comprising a troffer, a lighting window (140), and a lighting window retainer (150) configured to retain said lighting window (140) attached to said troffer, wherein the lighting window retainer (150) comprises a part (151) configured to host part of said lighting window (140), and wherein the lighting window retainer comprises a retainer opening (152), wherein the troffer comprises a troffer opening (132), and wherein the retainer opening (152) and the troffer opening (132) are configured in gaseous communication with each other. The invention also provides a system comprising the troffer-based lighting arrangement (100) and a device selected from the group consisting of a heating device, a ventilating device, and an air conditioning device, wherein said troffer-based lighting arrangement (100) further comprises a connection element for a functional connection with a gas port to provide a gaseous communication between the troffer opening (132) and the gas port.

### FIELD OF THE INVENTION

The invention provides a troffer-based lighting arrangement as well as a system comprising such troffer-based lighting arrangement. The invention is further related to controlling one or more conditions in a space, such as an office (room).

### BACKGROUND OF THE INVENTION

A fixture comprising a lighting function and an air supply function is known in the art. U.S. Pat. No. 7,815,327, for instance, describes a fixture comprising a central light source, an air supply duct having a connection point, in a center portion of the fixture, a flow straightener, wherein the flow straightener routes an air supply through an adjustable flow splitter and around the central light source and out through a series of slots arranged symmetrically perpendicular to an axis of the fixture, at least one light source on an outer edge of each of the series of slots arranged symmetrically perpendicular to the axis of the fixture, and wherein the central light source is shorter in length than the at least one light source on the outer edge of each of the series of slots, and an air mixing zone, which receives the air supply from an adjustable flow splitter, the air mixing zone located beneath the central light source and between the at least one light sources.

### SUMMARY OF THE INVENTION

A typical recessed, lensed luminaire has a door frame. It is herein suggested to provide an air function to such luminaire. The air function can be hidden within an opening or reveal around the perimeter of the door. Slots or openings can be placed in this reveal and air supply/transfer can be accomplished in this area. Recessed architectural lensed type luminaires do not usually offer any type of air function. They may not possess a door frame to hide the slots or openings for the air supply/transfer. Nevertheless, slots or louvers might be provided on the surface which detracts from the appearance of the luminaire.

Hence, it is an aspect of the invention to provide an alternative lighting arrangement, especially based on a troffer arrangement, which preferably further at least partly obviates one or more of above-described drawbacks. Especially, it is an aspect of the invention to provide a solution that minimizes construction and which minimizes visibility of slots or openings (having air functions). It is yet a further aspect of the invention to provide an alternative system that may be used to control lighting and/or indoor climate perception.

The present invention solves amongst others the issues of air supply/transfer by building it into the architecture of the luminaire rather than adding it as an added slot or louver. The air supply/transfer is especially accommodated through the lens retainers located at the ends of the lens. This may be accomplished by adding an architectural feature that is complimentary at best or at least neutral in appearance. By incorporating it into the design, it may be at least partly, or even essentially, unsightly and may not draw attention to its presence. Further, it may also keep the same look and feel of the original design of the luminaire by only slightly altering the appearance.

Hence, in a first aspect the invention provides a troffer-based lighting arrangement (“arrangement”) comprising a troffer, a lighting window (“window”; sometimes also indicated as “lens”), and a lighting window retainer (“retainer” or “lens retainer”) configured to retain said lighting window attached to said troffer, the troffer-based lighting arrangement comprises a side edge and a back plate, wherein one or more of said side edge and said back plate comprises said troffer opening, wherein the lighting window retainer comprises a part configured to host part of said lighting window, and wherein the lighting window retainer comprises a retainer opening directly opposite or directly next to the troffer opening, and wherein the retainer opening and the troffer opening are configured in gaseous communication with each other.

The expression “directly opposite or directly next to” is this respect means that essentially there are no parts of the troffer-based lighting arrangement located in the path of said gaseous communication between the retainer opening and the troffer opening. In particular the advantage is obtained that it is counteracted that gas flows along the light source to avoid accumulation of contamination, for example dust particles, on the light source as transported by flowing air. Rather the desired indoor climate, air, and/or temperature control function is provided by flowing air in which the air flow is from the entrance opening straight to the exit opening without flowing along the light source.

This invention allows a recessed architectural luminaire, with a central lens, to have air supply or return function without the need for a door frame and a wide reveal. This is accomplished by segregating a portion of the lens retainer, located at each end of the luminaire's lens, with a chamber that allows air to travel either in or out depending on the desired function. With the invention, there is no need for openings in the troffer parts, such as e.g. in the reflector. A part that may be necessary anyhow, the retainer, is now used in the gas (flow) infrastructure, providing thereby the possibility to include essentially “invisible” openings.

As indicated above, the invention provides a troffer-based lighting arrangement. Troffer-based lighting arrangements per se are known in the art. Herein, the term “troffer-based lighting arrangement” relates to an arrangement that may essentially be a single integral unit consisting of a plurality of components, amongst others the end plates and the lighting unit. Hence, the term “troffer-based lighting arrangement” may refer to the (functional) combination of troffer and lighting unit.

The term “troffer” is derived from a combination of trough and coffer, and in general may merely refer to the box-like fixture used to mount fluorescent tubes or solid state lighting units. The trough is the space, such as a concavity, essentially formed by the sides and ends (herein indicated as end plates) of the troffer.

The troffer may have a back plate. Alternatively, (or additionally), the lighting unit (at least partly enclosed by the troffer) may include a back plate. Hence, one or more of the lighting unit and troffer may provide a back plate for the troffer-based lighting arrangement.

The back plate (of e.g. the troffer) is commonly used to attach a ballast and/or control unit, which is/are mounted within the trough of the troffer. A ballast may be a necessary element for e.g. fluorescent lighting. The back plate may sometime be used as a base to mount the troffer lighting arrangement directly to the ceiling, or to other mounting means such as wires, a decorative box, or stanchions. However, in other embodiments the troffer may be recessed within a ceiling. In this way, e.g. a diffuser (lamellas) is coplanar with the ceiling surface. The invention is not limited to specific configuration of the troffer-based lighting arrangement to a ceiling or another element.

Note however that the troffer may not be limited to specific configurations, except for including at least a single end plate, in general two end plates. Note that the invention may also be defined in relation to a single end plate and another further end plate, or to a plurality (two, but optionally also more than two) of end plates. Here below, the invention is thus (further) defined in relation to two end plates.

The end plates may especially be physically connected to one or more bridging parts. Thereby, a frame is provided in which the lighting unit may be arranged.

The bridging part may in embodiments comprise e.g. reflectors. Therefore, in specific embodiments the troffer may comprise side elements and said end plates defining a trough-like space for engaging at least part of said lighting unit. Especially, the side elements comprise light reflective faces. The bridging parts, together with the end plates may provide the herein also mentioned “perimeter of the door”.

The troffer-based lighting arrangement comprises a lighting unit, with the lighting unit comprising at least a single light source. Further, the troffer-based lighting arrangement comprises a lighting window. The lighting window is transmissive for at least part of the light source light. Hence, the lighting window comprises light transmissive material.

The light transmissive material may comprise one or more materials selected from the group consisting of a transmissive organic material, such as selected from the group consisting of PE (polyethylene), PP (polypropylene), PEN (polyethylene napthalate), PC (polycarbonate), polymethylacrylate (PMA), polymethylmethacrylate (PMMA) (Plexiglas or Perspex), cellulose acetate butyrate (CAB), silicone, polyvinylchloride (PVC), polyethylene terephthalate (PET), including in an embodiment (PETG) (glycol modified polyethylene terephthalate), PDMS (polydimethylsiloxane), and COC (cyclo olefin copolymer). Especially, the light transmissive material may comprise an aromatic polyester, or a copolymer thereof, such as e.g. polycarbonate (PC), poly (methyl)methacrylate (P(M)MA), polyglycolide or polyglycolic acid (PGA), polylactic acid (PLA), polycaprolactone (PCL), polyethylene adipate (PEA), polyhydroxy alkanoate (PHA), polyhydroxy butyrate (PHB), poly(3-hydroxybutyrate-co-3-hydroxyvalerate) (PHBV), polyethylene terephthalate (PET), polybutylene terephthalate (PBT), polytrimethylene terephthalate (PTT), polyethylene naphthalate (PEN). Especially, the light transmissive material may have a light transmission of visible light of at least about 75%, such as at least about 80%. Hence, the light transmissive material is especially a polymeric light transmissive material.

The lighting window may also be used to have influence on the beam shape of the light emanating from the lighting window. Hence, the lighting window is often also indicated as “lens”. The lighting window may be integrated in the lighting unit, and the lighting unit as a whole may be arranged in the troffer to provide the arrangement. In other embodiments, the lighting unit and lighting window may be consecutively arranged in the troffer. The lighting window is retained in the troffer with one or more retainers. Also the lighting unit may be retained with the same one or more retainers, especially when the lighting unit includes the lighting window. Hence, the retainer is configured to retain said lighting window attached to said troffer and in further embodiments, the retainer is configured to retain the lighting unit and lighting window attached to said troffer. The term “retainer” may refer to a single retainer, but may also refer to a plurality of retainers, especially two retainers. The two retainers may be configured at the edges of the window.

The lighting unit especially includes a housing and a light source, which is especially associated with the housing. The housing may at least partly enclose the light source. The housing may include one or more reflectors for reflecting light of the light source. Further, the housing may include one or more (other) optical components for modifying the light of the light source and/or a beam shape of the light source light, such as the herein indicated lens. The lighting unit may include further components like e.g. an electrical wire, a sensor, etc. . . .

In embodiments, the term “light source” refers to a fluorescent lamp, such as a tubular fluorescent lamp, such as a T5 or T8 fluorescent tube. In yet other embodiments, the term “light source” refers to a solid state light source (such as a LED or laser diode).

The term “light source” may also relate to a plurality of light sources, such as 2-200 (solid state) LED light sources. Hence, the term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of semiconductor light sources may be configured on the same substrate. In embodiments, a COB is a multi LED chip configured together as a single lighting module.

The troffer-based lighting arrangement may be part of or may be applied in e.g. office lighting systems, household application systems, shop lighting systems, home lighting systems, accent lighting systems, theater lighting systems, fiber-optics application systems, warning sign systems, medical lighting application systems, indicator sign systems, decorative lighting systems, portable systems, automotive applications, (outdoor) road lighting systems, urban lighting systems, green house lighting systems, horticulture lighting, etc. . . .

Hence, this invention provides amongst others a (recessed architectural) luminaire to have air supply or return function without the need for a door frame and a wide reveal. This may be accomplished by segregating a portion of the lens retainer, located at each end of the luminaire's lens, with a chamber that allows air to travel either in or out depending on the desired function.

As indicated above, the lighting window retainer is configured to retain said lighting window attached to said troffer. To this end, the lighting window retainer comprises a part configured to host part of said lighting window. For instance, the window may be configured in a male-female arrangement in said part. The phrase “part configured to host part of said lighting window” may also refer to a plurality of parts. The part may essentially enclose a part of the window, such as especially an end part or edge (which may also be indicated as “head end”). Especially, the lighting window retainer is configured in physical contact with the troffer. For instance, the retainer may be an element integrated in the troffer, especially in an end plate, or may be an element attached to the troffer. The retainer may be attached to the troffer via Snap-On/snap-off means, or via permanent means, including locking elements, etc. . . . In this way, the retainer keeps the lighting window (and optionally the entire lighting unit) configured to the troffer, to provide in this way the troffer-based lighting arrangement. The lighting window retainer may also be in contact with one or more bridging parts. In yet other embodiments, the lighting window retainer may also be configured to retain or assist in retaining the one or more bridging parts (in the troffer).

In general, the troffer-based lighting arrangement will comprise two lighting window retainers, of which at least one includes the retainer opening. However, also both may include retainer openings. Therefore, in embodiments the troffer-based lighting arrangement comprises two lighting window retainers configured to retain said lighting window attached to said troffer (and each configured in gaseous communication with one or more troffer openings). The two lighting window retainers may especially be in physical contact with the end plates, such as attached to (with fastening means) (see further also above).

The lighting window retainer further comprises a retainer opening. The term “retainer opening” may also refer to a plurality of openings. Further, the term “opening” may refer to an opening having the functionality of an outlet or an inlet or both. For instance, dependent upon the configuration and conditions (cool) air may be provided via the retainer openings or (hot) air may be sucked out of a space via such retainer opening.

The term space may for instance relate to a (part of) hospitality area, such as a restaurant, a hotel, a clinic, or a hospital, etc. . . . The term “space” may also relate to (a part of) an office, a department store, a warehouse, a cinema, a church, a theatre, a library, etc. However, the term “space” also relate to (a part of) a working space in a vehicle, such as a cabin of a truck, a cabin of an air plane, a cabin of a vessel (ship), a cabin of a car, a cabin of a crane, a cabin of an engineering vehicle like a tractor, etc. . . . The term “space” may also relate to (a part of) a working space, such as an office, a (production) plant, a power plant (like a nuclear power plant, a gas power plant, a coal power plant, etc.), etc. For instance, the term “space” may also relate to a control room, a security room, etc. . . . Especially, the term “space” thus relates to an indoor space.

Further, the troffer-based lighting arrangement comprises an opening. The troffer-based lighting arrangement comprises front side, in use directed to a space such as a room, an office, etc., i.e. the side from which light of the troffer-based lighting arrangement emanates. The troffer-based lighting arrangement may further comprise an edge (including edges) and a back side (which may comprise or essentially consist of the above-mentioned back plate). The opening is comprised by one or more of the edge and the back side. Hence, this opening is essentially not visible to when viewing the troffer-based lighting arrangement from the front side. Would the troffer-based lighting arrangement be configured in a dropped ceiling, then this opening will not be visible in the space below the dropped ceiling. Especially, this opening may be comprised by the troffer. Hence, herein further the invention is (non-limitingly) described in relation to a troffer opening.

Therefore, in embodiments the troffer comprises a troffer opening. The retainer opening and the troffer opening are configured in gaseous communication with each other. Hence, in this way the troffer opening and the retainer opening can be part of an air and/or temperature control system, wherein (cool) air may be provided in the space where the troffer-based lighting arrangement is configured and/or wherein (hot) air may be provided in the space where the troffer-based lighting arrangement is configured. This may e.g. depend in time, and may e.g. be a function of the temperature, a user input, etc. etc. . . . Hence, in embodiments the troffer-based lighting arrangement may further comprise a connection element for a functional connection with a gas port of a device selected from the group consisting of a heating device, a ventilating device, and an air conditioning device, to provide a gaseous communication between the troffer opening and the gas port. The connection element is suitable for a functional connection with a gas port of a device selected, but such gas port of such device, or such device, are not (necessarily) part of the troffer-based lighting arrangement of such embodiments.

The terms “opening”, “troffer opening”, “retainer opening”, “connection element”, “port”, or “gas port” may each independently also refer to a plurality of such items. For instance, the troffer opening might comprise a plurality of troffer openings.

Instead of the term “gaseous communication” also the term “gaseous contact” may be used. The term “gaseous communication” refers e.g. to an arrangement of elements allowing a gas flow from one position to another position, or from one element to another element. When two elements are in gaseous communication there will be in general a gas channel, such as a conduit, a tube, etc., in between. Such gas channel is configured to allow the gas flow from the one element to the other, and in general also vice versa. The conduit can have any shape. For instance, a hollow element with only two openings that give access to the cavity of the hollow element provides two openings that are in gaseous communication. The term “gaseous communication” especially indicates that the elements that are in gaseous communication are configured, optionally with one or more other elements (like a gas channel), for gaseous communication between the elements. The term “gaseous communication” does not necessarily exclude the presence of a valve that may be configured to provide at least two positions, including one allowing gaseous communication, and another one including blocking the gaseous communication. Herein, essentially all elements that are indicated as in gaseous communication are permanently in gaseous communication. The term “functional connection” when referring to elements that can provide or receive gas may also refer to “gaseous communication”.

The use of the retainer for providing an opening or port may allow a solution wherein the opening is less clearly visible than in prior art solutions, or even essentially invisible. Further, the present solution allows a control of the air flow. These aspects are further elucidated below.

The troffer-based lighting arrangement may have the feature that the side edge comprises an end plate comprising the troffer opening and wherein the retainer opening is located in the lighting window retainer where the lighting window retainer contacts the end plate.

In embodiments, the troffer defines a troffer area A1 and the retainer opening defines a retainer opening area A2, having a ratio A2/A1≤0.1. For instance, this ratio may be in the range of 0.005-0.05. The term “troffer area” refers to the area essentially defined by the edges of the troffer-based lighting arrangement. In general, this is the area defined by the troffer-based lighting arrangement of an essentially horizontal plane when the troffer-based lighting arrangement is configured in use in a space. Hence, in embodiments this area can be essentially identical to the largest cross-sectional area. Thus, the area occupied by the retainer opening may be relatively small. Further, the retainers will be configured at the edges, and thus the distance between the retainer openings may be in the order of the length of the troffer-based lighting arrangement. In embodiments, the troffer-based lighting arrangement has an arrangement length (L1), wherein the lighting window has a window length (L2) and wherein the lighting window retainer has a retainer width (W1), wherein L2≥0.8*L1, W1≤0.2*L1, and L1≥L2+W1. Hence, the retainer may only occupy a small part of the visible area, i.e. the area visible to a user directed to the part of the troffer-based lighting arrangement from which the light emanates. In general, 0.8*L1≤L2≤L1.

The retainer especially has a retainer opening. The retainer may be a separate body, attached to the end plate(s). The retainer may thus also have a second retainer opening, in gaseous communication with the (first) retainer opening. The second retainer opening may be in gaseous communication with the troffer opening.

The invention also provides a lighting window retainer per se. The retainer may e.g. be made of polymeric material.

In embodiments, the retainer opening comprises louvres. This may add to the invisibility of the retainer opening. The louvres may also be used for other aspects; see also below.

The troffer-based lighting arrangement comprises a side edge and may comprise a back plate. The term edge may refer to the entire edge (this term may thus also refer to a plurality of edges). One or more of said side edge and said back plate comprises said troffer opening. In this way, the troffer opening may be in gaseous communication with the plenum (see also below), or an air and/or temperature control system, etc. . . . The side edge may comprise one or more end plates.

When the troffer-based lighting arrangement is configured for use, and would the troffer-based lighting arrangement be used to provide air into the space for which the troffer-based lighting arrangement is configured, a control of e.g. the direction of an air flow may be of interest. Further, when the troffer-based lighting arrangement is configured for use, and would the troffer-based lighting arrangement be used to retrieve are from the space for which the troffer-based lighting arrangement is configured, a control of the (in)flow may also be of interest. For instance, the flow per troffer-based lighting arrangement may be controlled in dependence of the number of troffer-based lighting arrangement for a space. Therefore, in embodiments the troffer-based lighting arrangement further comprises a flow control element, especially for controlling an opening area of one or more of the retainer opening and the troffer opening. Hence, the troffer-based lighting arrangement may also include a plurality of such flow control elements.

The flow control element for the troffer opening may also be indicated as “damper”. The flow control element may in embodiments be used to control a flow speed and/or flow direction, etc . . . , e.g. by manually changing the flow control element (such as a slit having a variable slid with, which can be varied through a turning nob. Hence, in embodiments the troffer-based lighting arrangement further comprises a flow control element for controlling an opening area of the retainer opening. Alternatively or additionally, embodiments the troffer-based lighting arrangement further comprises a flow control element for controlling an opening area of the troffer opening.

As indicated above, the retainer opening may comprise louvres (or “louvers”). With the louvres, the directionality of the flow may be controlled. In embodiments, the louvres have a fixed position. The louvres may be configured within the opening or downstream thereof, etc. . . . A louver (American English) or louvre (English) may be defined as a shutter or slat in or before an opening that may be angled. The angle of the slat may be adjustable, or fixed.

The terms “upstream” and “downstream” relate to an arrangement of items or features relative to the propagation of a gas from a gas generating means (here assuming a device that provides air via the troffer-based lighting arrangement, with the retainer opening essentially as end opening), wherein relative to a first position within a flow of gas from the gas generating means, a second position in the flow of gas closer to the gas generating means is “upstream”, and a third position within the beam of light further away from the light generating means is “downstream”. Note that in the present invention openings such as the retainer opening may be used to provide e.g. air (to a space) or to retrieve air (from a space).

In further embodiments, the troffer-based lighting arrangement may in addition to louvres or instead of louvres comprise a (further) element configured for controlling the flow, especially of air leaving the troffer-based lighting arrangement to the space for which the troffer-based lighting arrangement is configured. Therefore, in embodiments the troffer-based lighting arrangement may further comprise a flow control element for controlling a direction of a gas flow escaping from the retainer opening. In embodiments, the flow control element comprises one or more of (i) a Snap-On element for snapping on the troffer-based lighting arrangement, (ii) a sliding element for slidingly controlling an opening size of the retainer opening, and (iii) a deflection element for deflecting said gas flow, wherein the deflection element is configured in said retainer opening or downstream thereof. Note that louvres may be used as deflection element. Preferable said deflection element is adaptable. The Snap-On element and/or the sliding element may be configured such that a variable control of the air flow may be possible (which control can be electrically or manually, especially manually).

As indicated above, the flow control element may be used to control the direction of the flow that is provided into the space, i.e. may be configured to control the flow direction of a flow escaping from the retainer opening. This may e.g. also be used to direct the flow away from a perpendicular to the troffer-based lighting arrangement, for instance in embodiments even essentially parallel to the troffer-based lighting arrangement, i.e. essentially parallel to the lighting window. This may e.g. be desirable to allow a ventilation and/or cooling in the space, but without a flow (directly) directed to a position in front of the troffer-based lighting arrangement, such as e.g. a desk below the troffer-based lighting arrangement. Hence, in embodiments the flow control element is configured to direct a gas flow escaping from the retainer opening in a direction non-perpendicular to the troffer-based lighting arrangement.

The flow control element may be stationary and included in the troffer-based lighting arrangement, such as e.g. fixed louvres configured in the retainer opening. The flow control element may be controllable in more than one option (such direction of the flow and/or velocity of the flow). Such controllability may be used by an installer, leading to an essentially permanent position and/or direction for the flow control element. Alternatively or additionally, the flow control element may be controlled by a user. The flow control element may be controlled manually or electronically, etc. . . .

The troffer-based lighting arrangement has been elucidated above also in view of its application. Of course, the troffer-based lighting arrangement per se is not limited to specific applications. The troffer-based lighting arrangement may not only be applied in a horizontal position, as will commonly be the case, but a vertical arrangement or other arrangement may also be possible.

In use, the troffer-based lighting arrangement will especially be comprised by a space.

Especially, the troffer-based lighting arrangement will be attached to a ceiling or to a dropped ceiling. In the case of a dropped ceiling, a plenum is available above the dropped ceiling. A plenum is especially a part of a building that can facilitate air circulation for heating and/or air conditioning systems, by providing pathways for either heated/conditioned or return airflows, usually at greater than atmospheric pressure. Hence, the plenum may be at a higher, but may also be at a lower than atmospheric pressure. This may also depend upon the type of air and/or temperature control system is applied. The space between the structural ceiling and the dropped ceiling or under a raised floor is typically considered plenum. Hence, in yet a further aspect the invention also provides a space comprising said troffer-based lighting arrangement, such as a space including a dropped ceiling, wherein the troffer-based lighting arrangement is comprised by said dropped ceiling.

Further, the troffer-based lighting arrangement may especially be functionally coupled to a device or apparatus that makes use of the retainer (and troffer) opening(s).

Hence, in yet a further aspect the invention provides a system comprising the troffer-based lighting arrangement as defined herein and a device, especially selected from the group consisting of a heating device, a ventilating device, and an air conditioning device, wherein said troffer-based lighting arrangement further comprises a connection element for a functional connection with a gas port to provide a gaseous communication between the troffer opening and the gas port. Hence, the device is especially functionally coupled to the troffer-based lighting arrangement. The term “device” may also refer to a plurality of (functionally coupled) devices. The term “device” and “apparatus” may equally be used. In specific embodiments, the device is an HVAC system (“heating, ventilating/ventilation, and air conditioning”).

Therefore, in embodiments the system (or space) may further comprise a dropped ceiling, wherein the troffer-based lighting arrangement is comprised by said dropped ceiling.

The troffer-based lighting arrangement or the system as described above may thus be used for controlling lighting conditions but may additionally or alternatively be used to control indoor temperature and/or ventilation conditions. Hence, in yet a further aspect the invention also provides a method of controlling one or more conditions in a space, wherein the method comprises controlling one or more of (i) lighting conditions, (ii) ventilation, etc., and (iii) temperature in said space with said troffer-based lighting arrangement as defined herein, especially wherein the method comprises controlling lighting conditions.

To this end, the invention may further provide a control unit, which may be functionally coupled to (a) the troffer-based lighting arrangement and/or (b) the air and/or temperature control system. The term “control unit” may also refer to a plurality of control units which may optionally be functionally coupled. The control unit may comprise and/or be functionally coupled to a (remote) user input device for receiving instructions from a user. Alternatively or additionally, the control unit may be functionally coupled to one or more sensors. For instance, such one or more sensors may include a light sensor (light condition), a daylight sensor ((day)light condition), a temperature sensor (temperature condition), a humidity sensor (humidity condition), a pollutant sensor (e.g. a sensor for formaldehyde, etc . . . ) (pollutant or air quality condition), a motion sensor (presence condition), etc. . . . Further, the control unit may functionally be coupled to a clock, e.g. to execute a time related scheme of the one or more conditions.

In yet further embodiments, the method may (thus) further comprise controlling one or more (indoor) parameters selected from the group consisting of temperature, ventilation, and air quality in said space with a device selected from the group consisting of a heating device, a ventilating device, and an air conditioning device, wherein said troffer-based lighting arrangement is functionally coupled with said device by a gaseous communication between the troffer opening and a gas port of said device.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1b schematically depict some aspects related to the invention;

FIGS. 2a-2c schematically depict some embodiments;

FIGS. 3a-3d schematically depict some further aspects;

FIG. 4 schematically depicts an embodiment of the system.

The schematic drawings are not necessarily on scale.

### DETAILED DESCRIPTION OF THE EMBODIMENTS

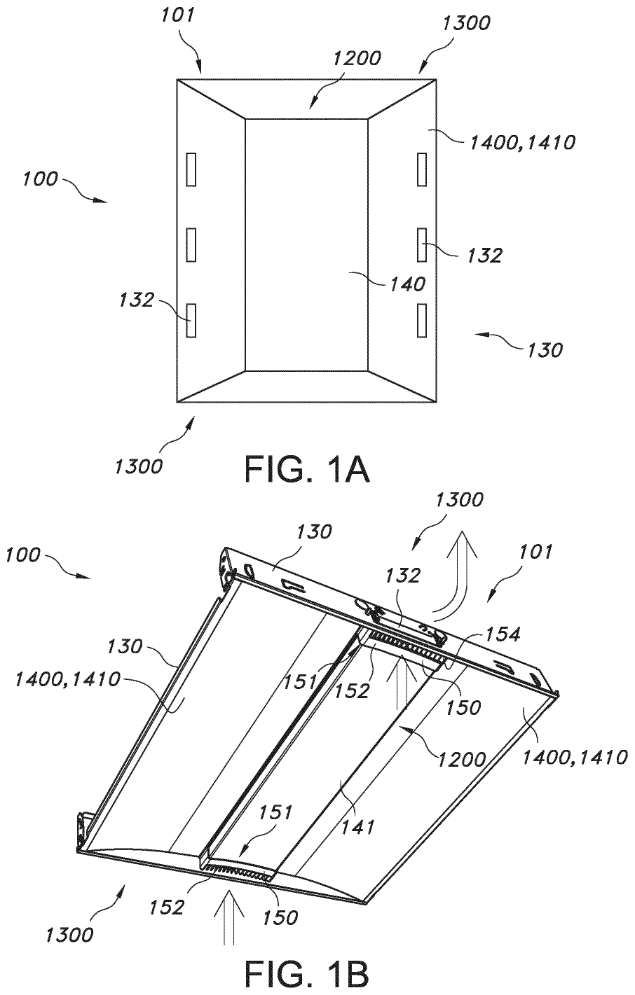

FIG. 1a schematically depicts troffer-based lighting arrangement 100 comprising a troffer 130 and a lighting window 140. The troffer-based lighting arrangement may further comprise one or more retainers, which are here not depicted. The troffer 130 comprises end plates 1300, and in between bridging elements 1400. The bridging elements may have reflective surfaces 1410 for controlling the beam size and direction of the light generated by a lighting unit, indicated with reference 1200, and having a lighting window 140. The bridging elements include openings 132, also indicated as troffer openings 132. The position of these openings 132 is less desirable. Therefore, the invention proposes another solution, which further also allows a higher controllability of the gas flow, if desired.

FIG. 1b essentially depicts a similar troffer-based lighting arrangement 100, but now lighting window retainers 150 are depicted. In general, such troffer-based lighting arrangement 100 comprises at both sides lighting window retainers 150, as depicted here. The lighting window retainers 150 are configured to retain said lighting window 140 attached to said troffer 130.

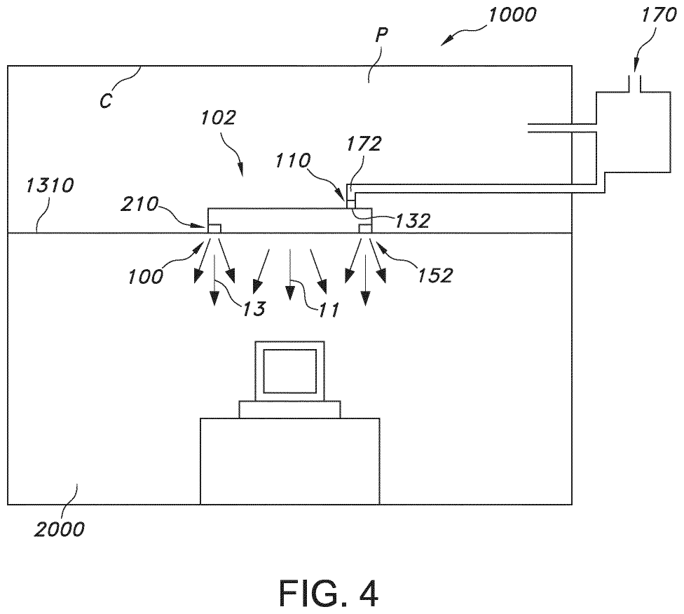

Further, the lighting window retainer 150 comprises a retainer opening 152. This retainer opening 152 can be used to suck gas, especially air, into the troffer-based lighting arrangement 100 for withdrawal by a device (not shown here, but further also described above and below), optionally via a plenum (see also below). Likewise, this retainer opening 152 can be used to provide gas, especially air, into the troffer-based lighting arrangement 100 for providing said gas in a space where the troffer-based lighting arrangement 100 is configured (see also FIG. 4). Hence, the troffer-based lighting arrangement 100 may be part of a device that provides ventilation and/or that controls the temperature and/or that controls air purity, etc. . . .

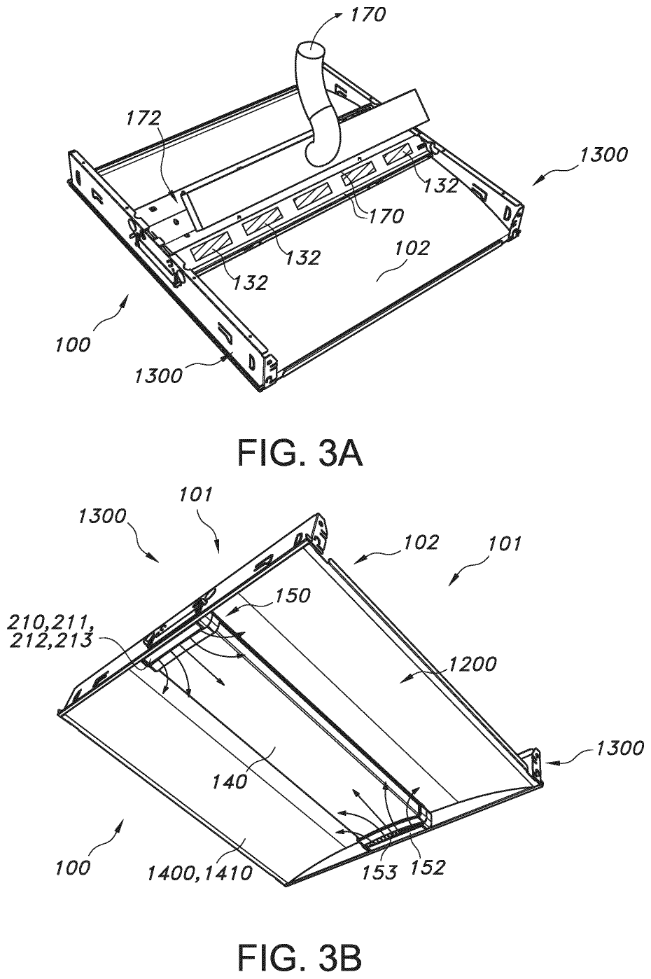

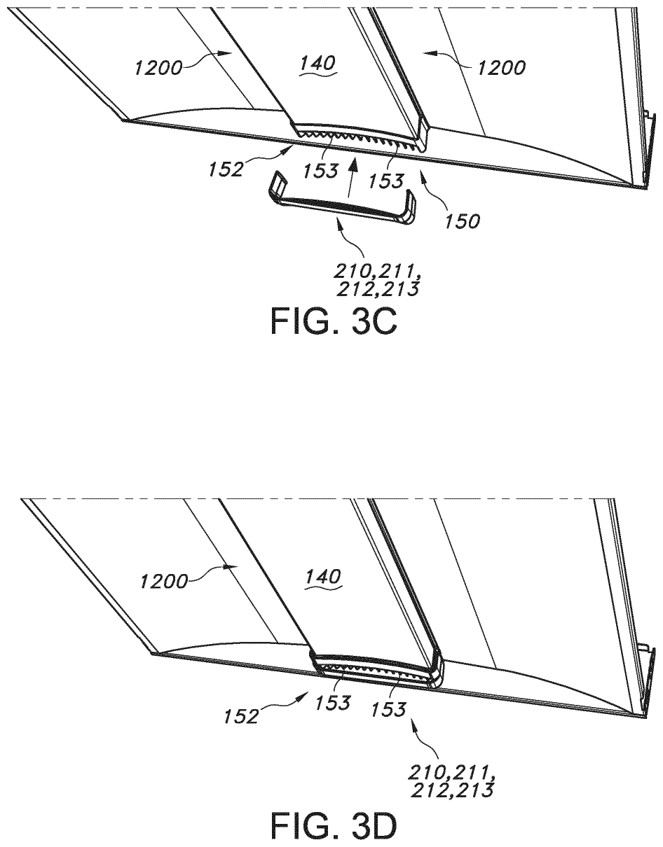

Also the troffer-based lighting arrangement 100 comprises a (further) opening; here the troffer 130 comprises a troffer opening 132. The retainer opening 152 and the troffer opening 132 are configured in gaseous communication with each other. Hence, the embodiment schematically depicted in FIG. 1b may essentially be the same as the embodiment schematically depicted in FIG. 1a, except for the fact that the openings are configured at an essentially different part of the troffer-based lighting arrangement 100, allowing a better control and allowing a more desirable appearance of the troffer-based lighting arrangement 100. Therefore, gas may flow from retainer opening to the troffer opening, and also vice versa. Hence, in embodiments the troffer-based lighting arrangement 100 comprises a side edge 101 and a back plate 102 (see also FIG. 3a), wherein one or more of said side edge 101 and said back plate 102 comprises the troffer opening 132 (as indicated herein, the term “troffer opening” may also refer to a plurality of troffer openings.

In FIG. 1b, the retainer opening 152 comprises louvres 154 (here shutters or slats which are configured within the retainer opening 152).

The window 140 may be used as lens. Further, the lighting unit 1200 may include a plurality of solid state light sources (not depicted), configured upstream of the window 140.

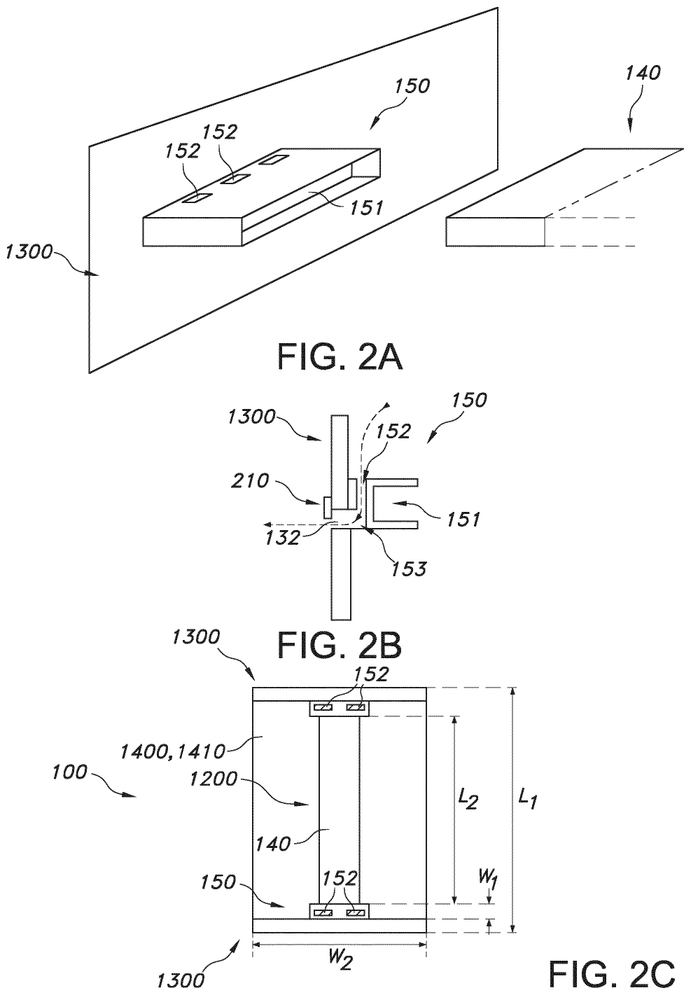

FIG. 2a very schematically depicts in more detail an embodiment of the lighting window retainer 150, which comprises a part 151 configured to host part of said lighting window 140. Further, the retainer 150 comprise said retainer opening 152. Here a plurality of retainer openings 152 are schematically depicted in FIG. 2a.

The retainer opening 152 is in gaseous communication with the troffer opening 132. Note that the such opening is not necessarily in gaseous communication of that part that is enclosed by the lighting window 140. In contrast, there may be no substantial gaseous communication between the retainer opening and the part of the lighting unit that is enclosed by the window 140/the part 151 configured to host part of said lighting window 140.

FIG. 2b shows that the retainer opening 152 is in gaseous communication with a troffer opening 132, which is here comprised by an end part 1300. Further, very schematically depicts a flow control element 210 for controlling an opening area of—in this embodiment—the troffer opening 132. The retainer 150 has a retainer opening 152. Here, the retainer 150 also has a second retainer opening, indicated with reference 153, in gaseous communication with the (first) retainer opening 152. The second retainer opening 153 may be in gaseous communication with the troffer opening 132. Hence, gas may flow from the second retainer opening to the troffer opening 132 and vice versa and gas may flow from the troffer opening to the retainer opening and vice versa. The invention also provides the retainer 150 per se.

FIG. 2c schematically depicts a top view of the troffer-based lighting arrangement 100. Here, the retainer opening comprises, by way of example, two retainer openings 152, for each retainer 150. The width of the retainer is indicated with reference W1. As can be seen, the width W1 of the retainer is much smaller than of the length L2 of the window 140 and the length L1 of the troffer-based lighting arrangement 100. Especially, the lighting window retainer 150 has a retainer width W1, with L2≥0.8*L1, W1≤0.2*L1, and L1≥12+W1. As there are two lighting window retainers 150, W1 is the sum of the individual widths of these retainers 150. Note that the length L2 of the window is in fact the effective length, i.e. the length that is not blocked downstream of the window by the retainer, as the retainer 150 may host part of the window 140. The width of the troffer-based lighting arrangement 100 is indicated with W2. Hence, W2*L1 is the troffer area A1. The area provided by the retainer openings 152 is herein indicated as A2 ((sum of) hatched areas in FIG. 2c).

FIG. 3a schematically depicts a further embodiment wherein the troffer-based lighting arrangement 100 further comprising a connection element 110 for a functional connection with a gas port 172 of a device 170 (device 170 is not depicted in FIG. 3a, as it is not part of the troffer-based lighting arrangement 100) selected from the group consisting of a heating device, a ventilating device, and an air conditioning device, to provide a gaseous communication between the troffer opening 132 and the gas port 172. Here, the device 170 is not shown, but may e.g. be an HVAC (see also FIG. 4). The gas port 172 comprises in this schematically depicted embodiment an air boot, though other options may of course also be possible. Further, by way of example, fitting with the embodiment of the air boot, the troffer opening comprises a plurality of troffer openings 132. All may be in gaseous communication with the device 170. In such embodiment, the troffer openings 132 may be at the back side, and a troffer opening at an end plate 1300 is not necessary anymore. This latter opening may be absent or may be closed in such embodiments. Optionally, this may be another opening, which may still be used, but which may not necessarily in contact with the retainer opening 152 (see FIG. 3b) or the troffer opening 132. Here, the troffer openings may be configured in a back plate 102 of the troffer-based lighting arrangement 100. The back plate can be defined as the part between the end plates 1300, which in use is directed to e.g. a ceiling.

Further, for this and other embodiments it may also be possible to use two retainers 150 with different functions, such as one to provide air and the other one to suck air.

FIG. 3b schematically depicts an embodiment of the troffer-based lighting arrangement 100 which further comprises a flow control element 210 for controlling an opening area of one or more of the retainer opening 152. Note that the embodiment schematically depicted can e.g. be a Snap-On element 211 for snapping on the troffer-based lighting arrangement 100. Alternatively or additionally, it may be a sliding element 212 for slidingly controlling an opening size of the retainer opening 152. Further, as also indicated above, the flow control element 210 may be a deflection element 213 for deflecting said gas flow, wherein the deflection element 213 is configured in said retainer opening 152 or downstream thereof. Such flow control element 210 may provide one or more of above functions, and in the presently schematically depicted embodiments substantially all the above listed functions are included. Hence, amongst others a flow control element 210 for controlling a direction of a gas flow escaping from the retainer opening 152. Here, in this embodiment the flow control element 210 is especially configured to direct a gas flow escaping from the retainer opening 152 in a direction non-perpendicular to the troffer-based lighting arrangement 100.

Hence, the flow control element 210 can herein be used to control the direction of the flow and/or the flow speed.

FIG. 3a schematically depicts a back view and FIG. 3b schematically depicts a front view of the troffer-based lighting arrangement 100.

FIG. 3c schematically depicts in more detail an embodiment of a flow control element 210, which includes two parts, see also FIG. 3d.

FIG. 4 schematically depicts an embodiment of a system 1000 comprising the troffer-based lighting arrangement 100 as defined and the device 170, which may especially be selected from the group consisting of a heating device, a ventilating device, and an air conditioning device. The troffer-based lighting arrangement 100 further comprises a connection element 110 for a functional connection with a gas port 172 to provide a gaseous communication between the troffer opening 132 and the gas port 172. This connection element may include a rotation closure, fixation means like screws, bolts, etc., or other means facilitation the functional connection between the two devices (via e.g. tubings and/or other means). The device 170 may e.g. be an HVAC system. Such device may serve more than one space 2000. However, by way of example a single space 2000 is depicted. Hence, the system may be used for and/or may include a dropped ceiling 1310, wherein the troffer-based lighting arrangement 100 is comprised by said dropped ceiling 1310. The troffer-based lighting arrangement 100 may essentially be at the same level, as schematically depicted here, or my be also dropped. The back plate 102 may be directed to the ceiling, whereas the lighting unit 1200 is configured to provide light 11 to the space 2000 (below the dropped ceiling 1310). Further, the invention is not limited to plenum based application. Here, the plenum is indicated with reference P. Reference C indicates the ceiling. By way of example, one of the retainers 150 further comprise flow control element 210 configured to direct a gas flow escaping from the retainer opening 152 in a direction non-perpendicular to the troffer-based lighting arrangement 100. An essential perpendicular direction may be less desirable for a person right below the troffer-based lighting arrangement 100. Reference 13 indicates a gas flow, which may be generated by the device 170 and is provided in the space 2000 via the troffer-based lighting arrangement 100, as the retainer opening 152 is via the troffer opening 132 in gaseous communication with the device 170.

Hence, with the troffer-based lighting arrangement 100 it is possible to control the lighting conditions in the space 2000 and/or to control one or more parameters selected from the group consisting of temperature, ventilation, and air quality in the space 2000.

The term “substantially” herein, such as in “substantially all light” or in “substantially consists”, will be understood by the person skilled in the art. The term “substantially” may also include embodiments with “entirely”, “completely”, “all”, etc.

Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A troffer-based lighting arrangement comprising a troffer, a lighting window, and a lighting window retainer configured to retain said lighting window attached to said troffer, the troffer-based lighting arrangement comprises a side edge and a back plate, wherein one or more of said side edge and said back plate comprises said troffer opening, wherein the lighting window retainer comprises a part configured to host part of said lighting window, and wherein the lighting window retainer comprises a chamber with a retainer opening, the retainer opening being directly opposite or directly next to the troffer opening, and wherein the retainer opening and the troffer opening are configured in gaseous communication only with each other via said chamber.

2. The troffer-based lighting arrangement according to claim 1, wherein the side edge comprises an end plate comprising the troffer opening and wherein the retainer opening is located in the lighting window retainer where the lighting window retainer contacts the end plate.

3. The troffer-based lighting arrangement according to claim 1, wherein the troffer defines a troffer area A1 and wherein the retainer opening defines a retainer opening area A2, having a ratio A2/A1≤0.1.

4. The troffer-based lighting arrangement according to claim 1 wherein the troffer-based lighting arrangement has an arrangement length (L1), wherein the lighting window has a window length (L2) and wherein the lighting window retainer has a retainer width (W1), wherein L2≥0.8*L1, W1≤0.2*L1, and L1≥L2+W1.

5. The troffer-based lighting arrangement according to claim 1 further comprising a connection element for a functional connection with a gas port of a device selected from the group consisting of a heating device, a ventilating device, and an air conditioning device, to provide a gaseous communication between the troffer opening and the gas port.

6. The troffer-based lighting arrangement according to claim 1 further comprising a flow control element for controlling an opening area of one or more of the retainer opening and the troffer opening.

7. The troffer-based lighting arrangement according to claim 1 wherein the retainer opening comprises louvres.

8. The troffer-based lighting arrangement according to claim 1 further comprising a flow control element for controlling a direction of a gas flow escaping from the retainer opening.

9. The troffer-based lighting arrangement according to claim 8,
wherein the flow control element comprises one or more of a Snap-On element for snapping on the troffer-based lighting arrangement, a sliding element for slidingly controlling an opening size of the retainer opening, and an adaptable deflection element for deflecting said gas flow, wherein the deflection element is configured in said retainer opening or downstream thereof.

10. The troffer-based lighting arrangement according to claim 1, comprising two lighting window retainers configured to retain said lighting window attached to said troffer.

11. A system comprising the troffer-based lighting arrangement according to claim 1 and a device selected from the group consisting of a heating device, a ventilating device, and an air conditioning device, wherein said troffer-based lighting arrangement further comprises a connection element for a functional connection with a gas port to provide a gaseous communication between the troffer opening and the gas port.

12. The system according to claim 11, wherein the device is an HVAC system.

13. The system according to claim 11, further comprising a dropped ceiling, wherein the troffer-based lighting arrangement is comprised by said dropped ceiling.

14. A method of controlling one or more conditions in a space, the method comprising controlling lighting conditions in said space with said troffer-based lighting arrangement according to claim 1.

15. The method according to claim 14, wherein the method further comprises controlling one or more parameters selected from the group consisting of temperature, ventilation, and air quality in said space with a device selected from the group consisting of a heating device, a ventilating device, and an air conditioning device, wherein said troffer-based lighting arrangement is functionally coupled with said device by a gaseous communication between the troffer opening and a gas port of said device.
